(19) United States
(12) Patent Application Publication
(10) Pub. No.: US 2025/0074488 A1
(43) Pub. Date: Mar. 6, 2025

(54) COLLAPSIBLE TROLLEY

(71) Applicant: JI-SAN HUANG, Xihu Township (TW)

(72) Inventor: JI-SAN HUANG, Xihu Township (TW)

(21) Appl. No.: 18/214,367

(22) Filed: Sep. 3, 2023

(51) Int. Cl. B62B 1/12; B62B 1/14; B62B 5/06

(52) U.S. Cl. CPC B62B 1/125; B62B 1/142; B62B 5/065; B62B 2205/14; B62B 2301/04

(57) ABSTRACT

A collapsible trolley includes a handle unit, an adjustment unit, a bearer, a strut and a strut-positioning unit. The handle unit includes two telescopic elements. The adjustment unit is operable to adjust the length of the telescopic elements. The bearer is connected to the handle unit. The strut is pivotally connected to the handle unit. The strut-positioning unit is operable to keep the strut in position relative to the handle unit. A user can disable the strut-positioning unit to release the strut from the handle unit without having to use any hand or bend.

### BACKGROUND OF INVENTION

### 1. Field Of Invention

The present invention relates to a tool for transportation of cargo and, more particularly, to a collapsible trolley.

### 2. Related Prior Art

Trolleys are used to transport a large amount of cargo for efficiency of the transportation, security of the cargo and safety of users of the trolleys. A conventional trolley includes a handle unit, a nose plate, two major casters and a minor caster. The nose plate is pivotally connected to a lower section of the handle unit. The major casters are connected to two lateral sides of the lower section of the handle unit. The minor caster is connected to a rear face of the lower section of the handle unit.

The minor caster is normally locked to the handle unit by a locking element to allow the nose plate to contact a floor to bear cargo. The locking element is disabled to release the minor caster from the handle unit after the cargo is loaded on the nose plate. Now, the minor caster is allowed to roll on the floor as well as the major casters for smooth transportation of the cargo.

However, a user has to use a first hand to hold the handle unit, bend and use and a second hand to disable the locking element. The second hand can get dirty by mud and/or dirt on the floor. The second hand can get hurt by a sharp article on the floor.

Furthermore, when the user bends and uses the second hand to disable the locking element, the user can accidentally use the first hand to push the handle unit. Moreover, after the locking element is disabled, the minor caster can fall due to weight. Thus, collapsible trolley can vibrate so that the cargo can fall from the nose plate or the collapsible trolley can move and hit and damage an object or hurt a person.

The present invention is therefore intended to obviate or at least alleviate the problems encountered in the prior art.

### SUMMARY OF INVENTION

It is the primary objective of the present invention to provide a safe and convenient collapsible trolley.

To achieve the foregoing objective, the collapsible trolley includes a handle unit, an adjustment unit, a bearer, a strut and a strut-positioning unit. The handle unit includes two external tubes, two braces, two major casters, two internal tubes and a grip. Each of the external tubes includes an aperture. The first brace is connected to the external tubes. The second brace is connected to the external tubes above the first brace. The major casters are connected to two ends of the second brace. Each of the internal tubes is movably inserted in a corresponding one of the external tubes and includes multiple orifices. The grip is connected to the internal tubes. The adjustment unit includes a cover, a lever, two latches and a first torque spring. The cover is connected to the external tubes and includes a space, an upper slot in communication with the space, and two rear slots in communication with the space. The lever includes a primary portion located in the space and an extensive portion extending from the primary portion. The extensive portion extends from the space through the upper slot. The latches are located in the space. Each of the latches includes a first end pivotally connected to an end of the primary portion and a second end insertable in a selected one of the orifices of a corresponding one of the internal tubes through the aperture of a corresponding one of the external tubes. The torque spring includes an end connected to the primary portion and another end connected to a portion of the cover in the space, thereby biasing the second end of each of the latches in a selected one of the orifices of a corresponding one of the internal tubes through the aperture of a corresponding one of the external tubes. The bearer includes a frame and a connector. The frame is pivotally connected to the second brace. The connector includes an end non-movably connected to the frame and another end pivotally connected to the second brace. The strut includes two connectors and a plate. Each of the connectors includes an end pivotally connected to the second brace. The plate is connected to the connectors and formed with a window. The minor caster is connected to the plate. The strut-positioning unit includes a lower crossbar, an upper crossbar and a linking rod. The lower crossbar is located below the plate. The upper crossbar is connected to the external tubes. The linking rod extends through the window and includes a lower end connected to the lower crossbar and an upper end pivotally connected to the upper crossbar. The second torque spring includes an end connected to the upper crossbar and another end connected to the linking rod.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a collapsible trolley according to the preferred embodiment of the present invention;

FIG. 2 is a perspective view of the collapsible trolley in an extended position other than a collapsed position shown in FIG. 1;

FIG. 3 is an exploded view of the collapsible trolley shown in FIG. 2;

FIG. 4 is an enlarged partial view of the collapsible trolley shown in FIG. 2;

FIG. 5 is an exploded view of the collapsible trolley shown in FIG. 4;

FIG. 6 is a rear view of the collapsible trolley shown in FIG. 4;

FIG. 7 is a side view of the collapsible trolley shown in FIG. 1;

FIG. 8 is a side view of the collapsible trolley in another position than shown in FIG. 1; and

FIG. 9 is an enlarged partial view of the collapsible trolley shown in FIG. 8.

### DETAILED DESCRIPTION OF PREFERRED EMBODIMENT

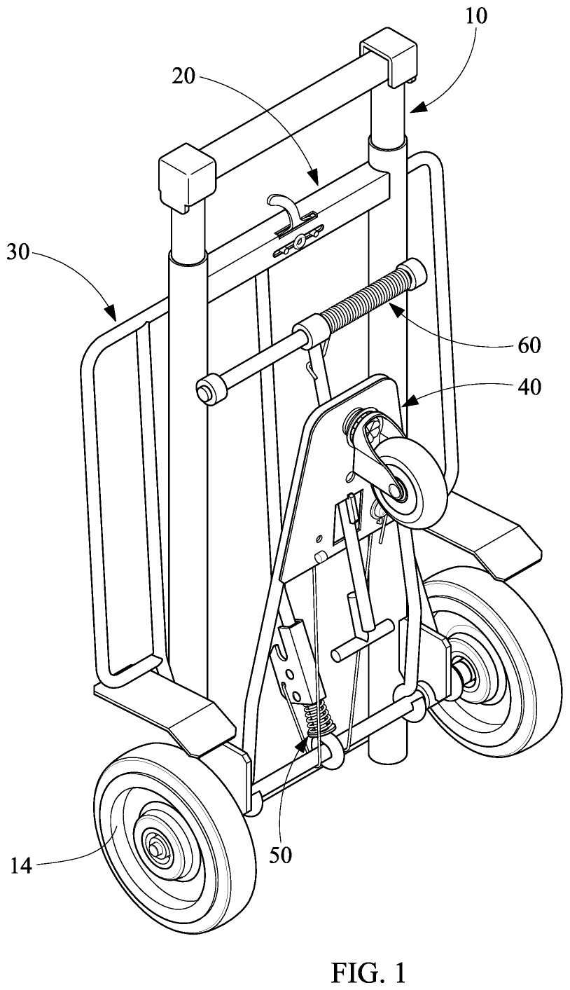

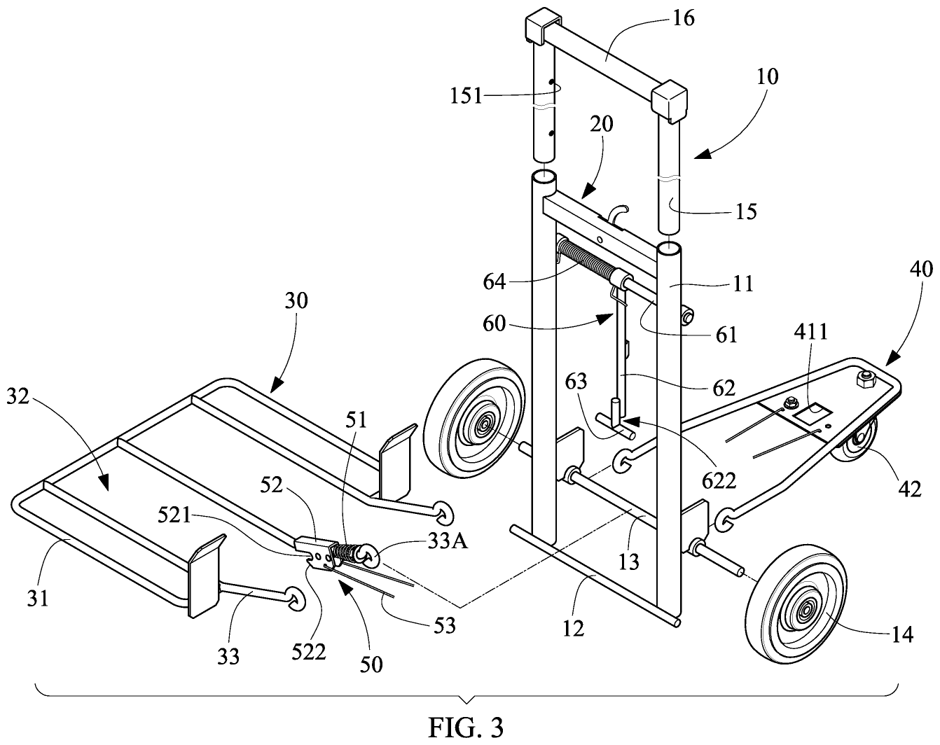

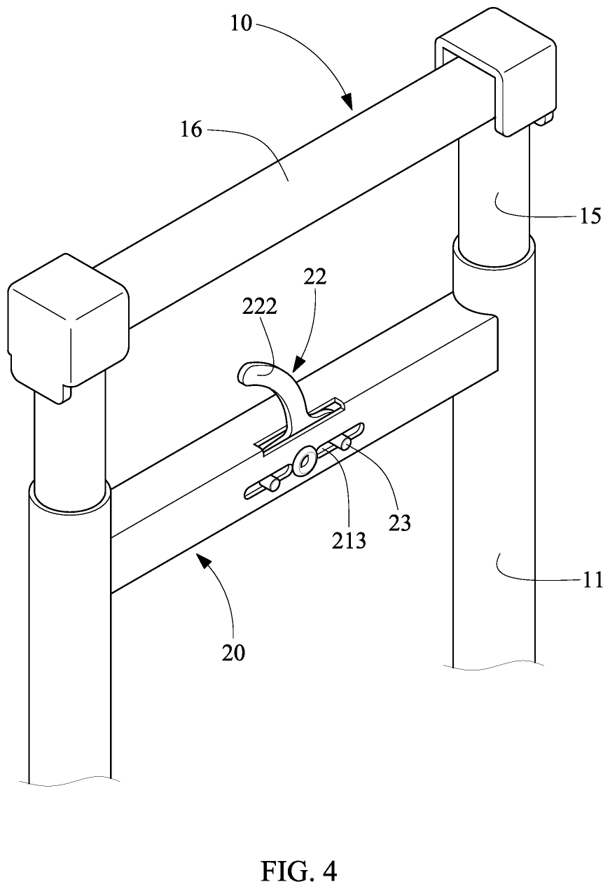

Referring to FIGS. 1 through 6, a collapsible trolley includes a handle unit 10, an adjustment unit 20, a bearer 30, a strut 40, a bearer-positioning unit 50 and a strut-positioning unit 60 according to the preferred embodiment of the present invention.

The handle unit 10 includes two external tubes 11, two braces 12 and 13, two major casters 14, two internal tubes 15 and a grip (or “handle bar”) 16.

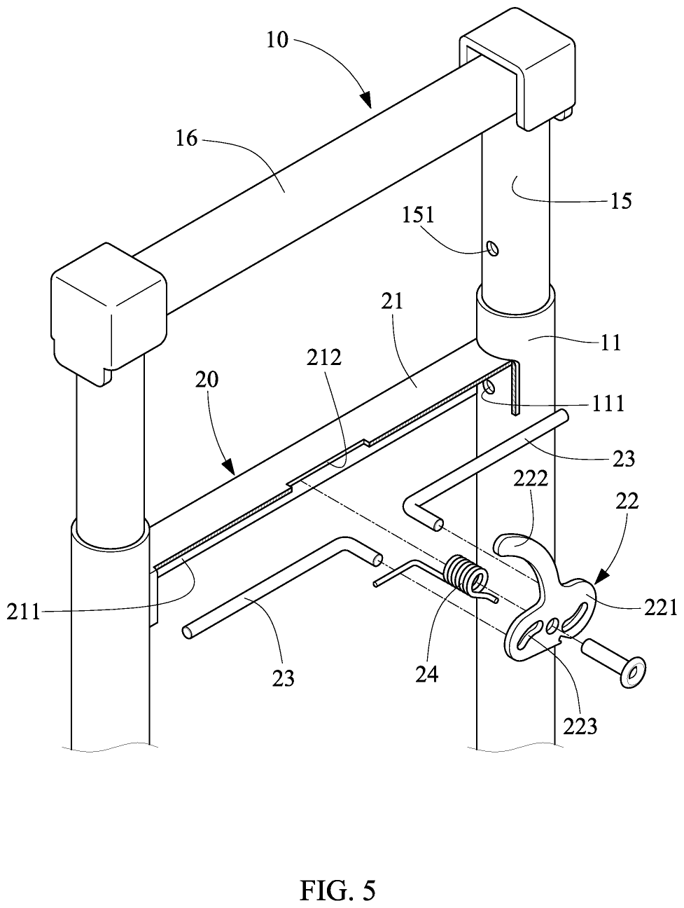

Each of the external tubes 11 includes an aperture 111 in an upper section (FIG. 5).

Each of the braces 12 and 13 includes two ends each of which is connected to a lower section of a corresponding one of the external tubes 11. The braces 12 and 13 extend in parallel to each other. The brace 12 is located higher than the brace 13.

Each of the major casters 14 is rotationally connected to a lateral (or “external”) side of the lower section of a corresponding one of the external tubes 11. Preferably, the major casters 14 are rotationally connected to the ends of the second brace 13 that horizontally extend beyond the lower sections of the external tubes 11.

Each of the internal tubes 15 includes a lower end movably inserted in a corresponding one of the external tubes 11 and an upper end movably located out of the corresponding external tube 11. Thus, each of the internal tubes 15 and the corresponding external tube 11 form a telescopic (or “extensible”) element. Each of the Each of the internal tubes 15 includes multiple orifices 151.

The grip 16 includes two ends each of which is connected to the upper end of a corresponding one of the internal tubes 15.

The adjustment unit 20 is operable to keep the internal tubes 15 in a selected one of multiple positions relative to the external tubes 11 as a selected one of the orifices 151 of each of the internal tubes 15 is in communication in the aperture 111 of the corresponding external tube 11. The adjustment unit 2 includes a cover 21, a lever 22, two latches 23 and a torque spring 24.

The cover 21 includes two ends connected to the upper sections of the external tubes 11. The cover 21 further an upper strip, a rear strip and a front strip so that the cover 21 is an inverted U-shaped element in a cross-sectional view.

The cover 21 further a space 211, an upper slot 212 and two rear slots 213. The space 211 is defined by the upper, rear and front strips of the cover 21. The upper slot 212 is made in the upper strip of the cover 21. The rear slots 213 are made in the rear strip of the cover 21 along a same horizontal line.

Referring to FIG. 5, the lever 22 is pivotally connected to the cover 21. The lever 22 includes a primary portion 221, an extensive portion 222 and two arched slots 223. The extensive portion 222 extends from the primary portion 221 at the right angle. The arched slots 223 are made in the primary portion 221.

The primary portion 221 is located in the space 211 and pivotally connected to the rear or front strip of the cover 21. The extensive portion 222 extends from the space 211 through the upper slot 212.

The latches 23 are inserted in the space 211. Each of the latches 23 is an L-shaped element including an internal end inserted in a corresponding one of the arched slots 223 and an external end insertable in the aperture 111 through a selected one of the orifices 151.

The torque spring 24 is located in the space 211. The torque spring 24 includes an end in contact with the primary portion 221 and another end in contact with a wall of the space 211. Thus, the lever 22 is biased by the torque spring 24. Each of the latches 23 an end inserted in a corresponding one of the arched slots 223 and another end insertable in a selected one of the orifices 151 through the aperture 111.

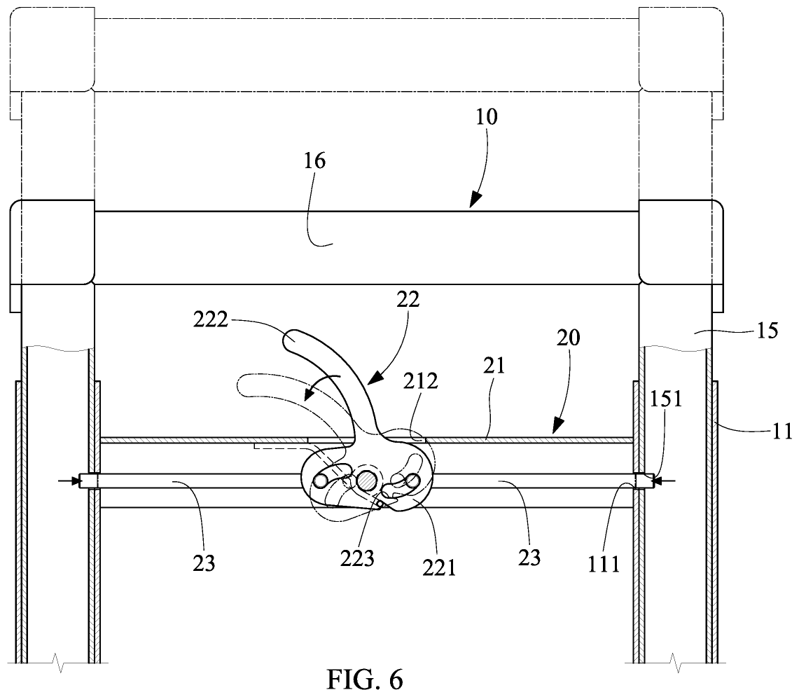

Referring to FIGS. 5 and 6, the bearer 30 includes a frame 31 and three connectors 33. The frame 31 includes a middle rod (not numbered) formed between two lateral rods (not numbered). Each of the connectors 33 includes an end connected to the middle rod or the frame 31 and a loop 33A for holding the brace 13.

The strut 40 includes a frame 43 and a plate 44. The frame 43 includes a middle rod (not numbered) extending between two connectors 41. Each of the connectors 41 includes a loop (not numbered) for holding the brace 13. The plate 44 is formed with a window 411 and connected to the connectors 41. The minor caster 42 is connected to the plate 44.

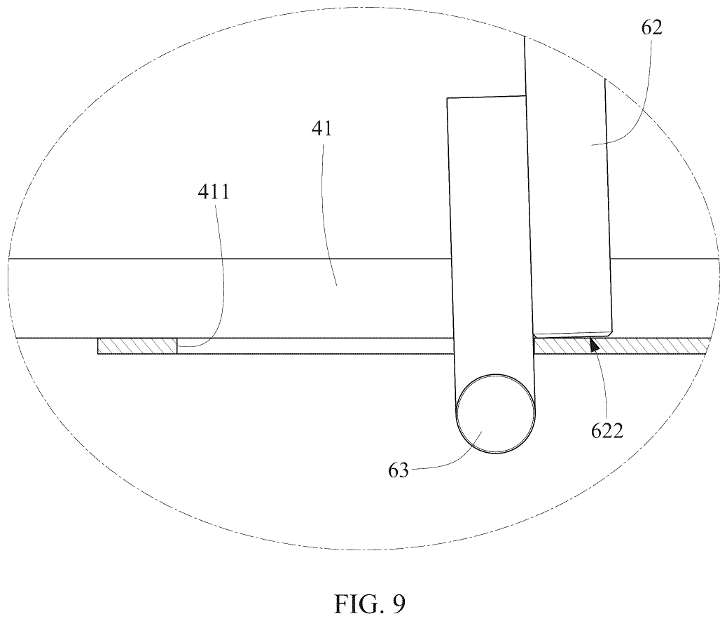

Referring to FIGS. 1, 2, 3, and 7 through 9, the bearer-positioning unit 50 includes a compression spring 51, a shackle 52 and a cable 53. The compression spring 51 and the shackle 52 are movably located on a middle one of the connectors 33. The compression spring 51 is compressed between the shackle 52 and the loop 33A of the middle connector 33. The shackle 52 includes a recess 521 for receiving the brace 12. The cable 53 includes an end connected to the shackle 52 and another end connected to the strut 40. The cable 53 is wound around the brace 12. The strut 40 is operable to pull the shackle 52 to disengage the shackle 52 from the brace 12.

The strut-positioning unit 60 includes an upper crossbar 61, a linking rod 62, a lower crossbar 63 and a torque spring 64. The linking rod 62 includes an upper end pivotally connected to the upper crossbar 61 and a lower end non-movably connected to the lower crossbar 63. The upper crossbar 61 is located between and connected to the external tubes 11. The lower end of the linking rod 62 extends through the window 411 of the plate 44.

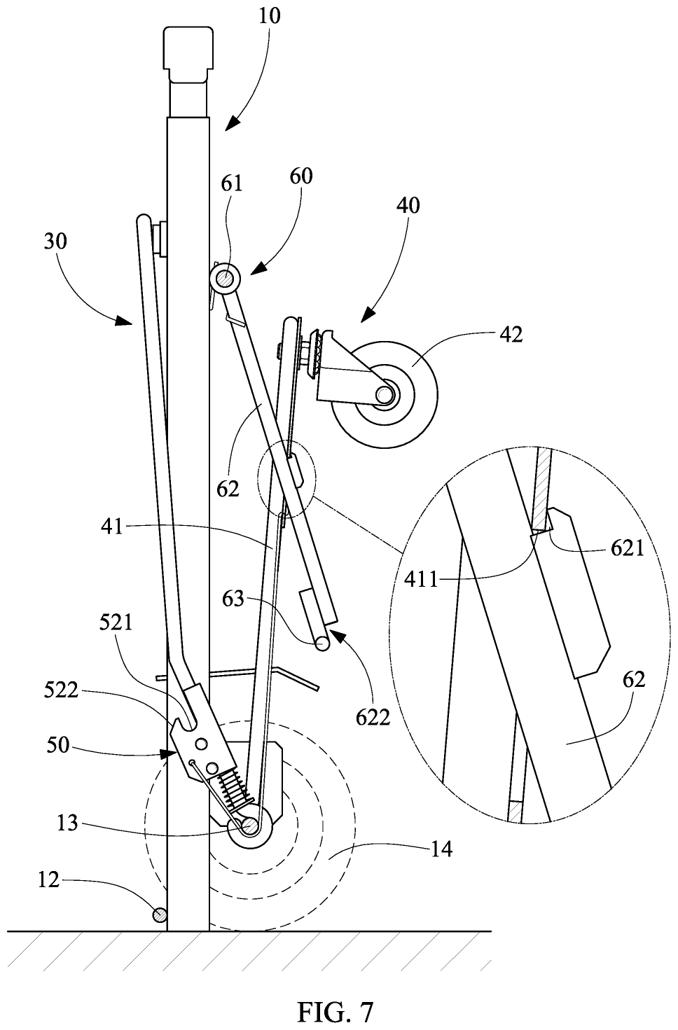

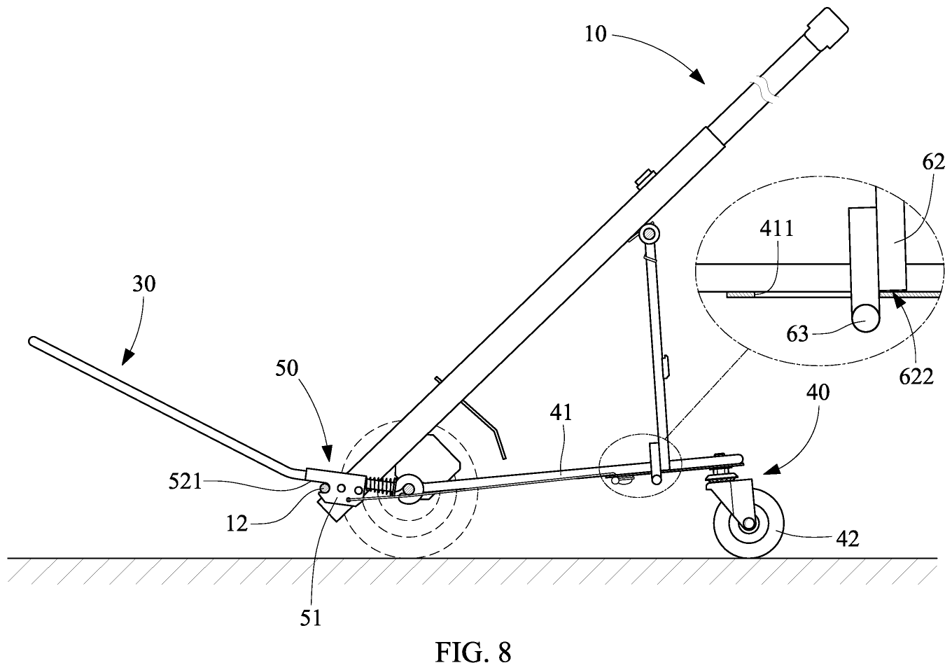

The linking rod 62 includes a notch 621 and a shoulder 622. The notch 621 is operable for receiving an edge of the window 411 of the strut 40 to restrain the strut 40 (FIG. 7). The shoulder 622 is operable to abut against the plate 44 near the edge of the window 411 (FIG. 8). The lower crossbar 63 is located below the plate 44. The lower crossbar 63 is operable to abut against a lower face of the plate 44 to limit the pivoting of the strut 40 relative to the handle unit 10.

The torque spring 64 is located around the upper crossbar 61. The torque spring 64 includes an end connected to the upper crossbar 61 and another end connected to the linking rod 62 to pivot the linking rod 62 from the handle unit 10.

Referring to FIGS. 5 and 6, to adjust the extent to which the internal tube 15 extends from the external tube 11, the extensive portion 222 of the lever 22 is operated pull the latches 23 from the selected orifices 151 of the internal tubes 15. The torque spring 24 is loaded as the extensive portion 222 of the lever 22 is operated.

Now, the internal tubes 15 are movable up and down relative to the external tubes 11. When a desired length of the telescopic elements is reached, the lever 22 is released to allow the torque spring 24 to return the lever 22 to its original position. The external end of each of the latches 23 is inserted in a newly selected one of the orifices 151 of a corresponding one of the internal tubes 15.

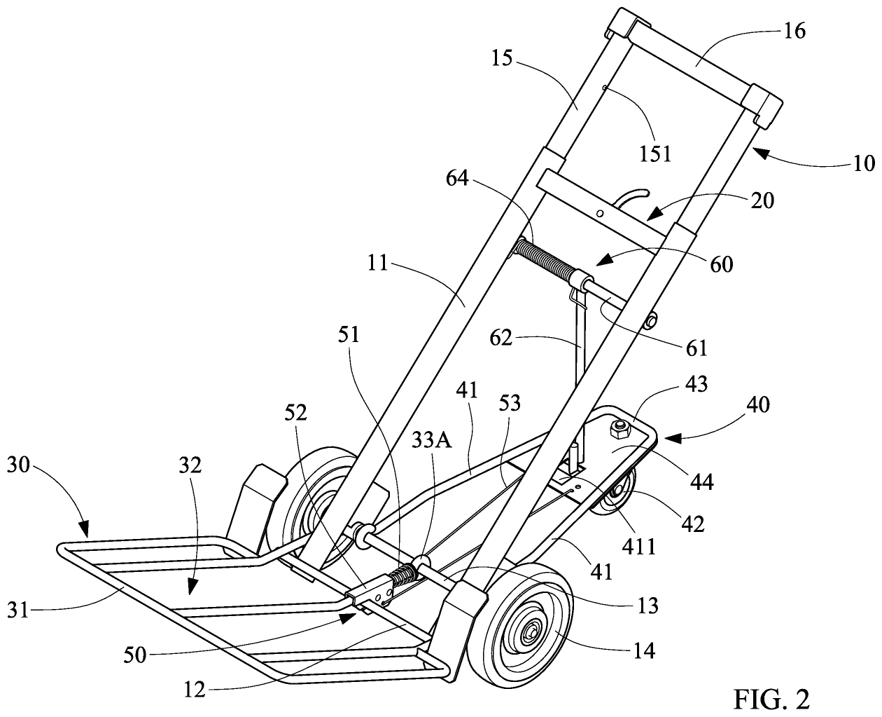

Referring to FIGS. 1 and 2, the bearer 30 is located in front of the handle unit 10 and the strut 40 is located behind the handle unit 10. A user can kick the bearer 30 and the strut 40 toward the handle unit 10, i.e., collapse the collapsible trolley, without having to bend and use a hand to unlock and pivot the bearer 30 and strut 40 toward the handle unit 10.

Referring to FIGS. 1, 2, 7 and 8, to extend the collapsible trolley to transport cargo, the user treads on a free end of the bearer 30 to pivot the bearer 30 from the handle unit 10. When the bearer 30 is fully extended from the handle unit 10, the bearer 30 is abutted against the first brace 12 of the handle unit 10. The shackle 52 of the bearer-positioning unit 50 hooks the first brace 12. The chamfer 522 of the shackle 52 allows the shackle 52 to move past the brace 12 so that the compression spring 51 is compressed. Finally, the recess 521 of the shackle 52 receives the brace 12.

Thus, the bearer 30 is fully extended from the handle unit 10. The collapsible trolley can sand on a floor. Cargo can be loaded on the bearer 30.

The user holds the handle unit 10 and kicks the strut 40 toward the handle unit 10 so that the window 411 of the strut 40 is moved from the notch 621 of the linking rod 62. The strut 40 falls due to weight and pivots about the second brace 13. Then, the plate 44 falls on the lower crossbar 63, which is connected to the lower end of the linking rod 62.

Then, the torque spring 64 pivots the linking rod 62 from the handle unit 10. Thus, the shoulder 622 of the linking rod 62 is abutted against the plate 44.

The user treads on the strut 40 to pivot the handle unit 10 toward the floor, i.e., tilt the handle unit 10. Accordingly, the bearer 30 is lifted from the floor. Now, the user transports the cargo.

As the strut 40 is fully extended, the cable 53 of the bearer-positioning unit 50 becomes slack. Thus, the compression spring 51 is allowed to engage the shackle 52 with the brace 12. Thus, the bearer 30 cannot be pivoted relative to the handle unit 10.

The user collapses the collapsible trolley after transporting the cargo. To this end, the handle unit 10 is lifted to lay the bearer 30 on the floor. Accordingly, the strut 40 and the minor caster 42 are lifted. The shoulder 622 of the linking rod 62 is moved from the plate 44.

Now, the user kicks the strut 40 toward the handle unit 10. Thus, the linking rod 62 is pivoted toward the handle unit 10 as well as the strut 40. The shoulder 622 of the linking rod 62 is disengaged from the plate 44. The strut 40 is inserted through the window 411. Finally, the edge of the window 411 of the strut 40 is located in the notch 621 of the linking rod 62. Now, the strut 40 is collapsed.

The strut 40 pulls the cable 53 to disengage the shackle 52 from the brace 12, thereby allowing the bearer 30 is unlocked. Meanwhile, the compression spring 51 is loaded.

Then, the user kicks the bearer 30 toward the handle unit 10, thereby pivoting the bearer 30 about the second brace 13. Finally, the bearer 30 is collapsed.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A collapsible trolley comprising
a handle unit (10) comprising:
two external tubes (11) each of which comprises an aperture (111);
a first brace (12) connected to the external tubes (11);
a second brace (13) connected to the external tubes (11) above the first brace (12);
two major casters (14) connected to two ends of the second brace (13);
two internal tubes (15) each of which is movably inserted in a corresponding one of the external tubes (11) and comprises multiple orifice (151); and
a grip (16) connected to the internal tubes (15);
an adjustment unit (20) comprising:
a cover (21) connected to the external tubes (11) and comprising a space (211), an upper slot (212) in communication with the space (211), and two rear slots (213) in communication with the space (211);
a lever (22) comprising a primary portion (221) located in the space (211) and an extensive portion (222) extending from the primary portion (221), wherein the extensive portion (222) extends from the space (211) through the upper slot (212);
two latches (23) located in the space (211), wherein each of the latches (23) comprises a first end pivotally connected to an end of the primary portion (221) and a second end insertable in a selected one of the orifices (151) of a corresponding one of the internal tubes (15) through the aperture (111) of a corresponding one of the external tubes (11); and
a first torque spring (24) comprising an end connected to the primary portion (221) and another end connected to a portion of the cover (21) in the space (211), thereby biasing the second end of each of the latches (23) in a selected one of the orifices (151) of a corresponding one of the internal tubes (15) through the aperture (111) of a corresponding one of the external tubes (11);
a bearer (30) comprising:
a frame (31) pivotally connected to the second brace (13); and
a connector (33) comprising an end non-movably connected to the frame (31) and another end pivotally connected to the second brace (13);
a strut (40) comprising:
two connectors (41) each of which comprises an end pivotally connected to the second brace (13);
a plate (44) connected to the connectors (41) and formed with a window (411); and
a minor caster (42) connected to the plate (44); and
a strut-positioning unit (60) comprising:
a lower crossbar (63) located below the plate (44);
an upper crossbar (61) connected to the external tubes (11); and
a linking rod (62) extending through the window (411) and comprising a lower end connected to the lower crossbar (63) and an upper end pivotally connected to the upper crossbar (61);
a second torque spring (64) comprising an end connected to the upper crossbar (61) and another end connected to the linking rod (62).

2. The collapsible trolley according to claim 1, wherein the connector (33) of the bearer (30) comprises a loop (33A) for holding the second brace (13).

3. The collapsible trolley according to claim 1, further comprising a bearer-positioning unit (50) between the handle unit (10) and the bearer (30).

4. The collapsible trolley according to claim 3, wherein the bearer-positioning unit (50) comprises:
a shackle (52) movable along the connector (33) of the bearer (30) and operable for engagement with the first brace (12);
a compression spring (51) compressed a portion of the connector (33) of the bearer and the shackle (52); and
a cable (53) extending around the first brace (12) and comprising an end connected to the shackle (52) and another end connected to the strut (40).

5. The collapsible trolley according to claim 4, comprises the shackle (52) comprises a recess (521) for receiving the first brace (12) and a chamfer (522) for allowing smooth movement of the first brace (12) into the recess (521).

6. The collapsible trolley according to claim 1, wherein the linking rod (62) comprises a notch (621) for receiving an edge of the window (411).

7. The collapsible trolley according to claim 1, wherein the rear slots (213) are arranged along a same horizontal line.

8. The collapsible trolley according to claim 1, wherein the lever (22) further comprises two arched slots (223) each of which receives the first end of a corresponding one of the latches (23).

9. The collapsible trolley according to claim 7, wherein the latches (23) are L-shaped.

10. The collapsible trolley according to claim 1, wherein the second torque spring (64) comprises a helical section extending around the upper crossbar (61).
